(19) United States
(12) Patent Application Publication
(10) Pub. No.: US 2020/0039659 A1
(43) Pub. Date: Feb. 6, 2020

(54) Container for Receiving, Storing and Dispensing Liquids and/or Viscous Substances, in Particular Fuel, Propellant or Drinking Water, Method for Producing Same and Use Thereof

(71) Applicant: MT Aerospace AG, Augsburg (DE)

(72) Inventor: Stefan Weiland, Gersthofen (DE)

(21) Appl. No.: 16/470,203

(22) PCT Filed: Jan. 2, 2018
(86) PCT No.: PCT/EP2018/050075

§ 371 Date: Oct. 11, 2019

(30) Foreign Application Priority Data
Jan. 2, 2017 (DE) 10 2017 100 034.8

(51) Int. Cl. B64D 37/02; B64G 1/40

(52) U.S. Cl. CPC B64D 37/02; F02K 9/44; B64G 1/402

(57) ABSTRACT

The invention relates to a container for receiving, storing, and dispensing liquids and/or viscous substances, in particular fuel, propellant, or drinking water, comprising a casing (12) with a microscopic surface structure (16) that is integrally formed on at least some parts of the casing (10) and comprises at least one approximately groove- and/or channel-shaped capillary (20) which is arranged in an interior (14) of the container (10) on the inner face (18) of the casing (12) such that an end (22) of the capillary faces an outlet opening (24) of the container (10), which extends into a region (24) that is adjacent to or borders the outlet opening (24) of the container (10), and which is made of two lateral walls (26) that are paired together and run together for conveying the liquid and/or the viscous substance within the capillary (20) to the outlet opening (24) of the container (10). The invention also relates to a method for producing the container and to the use thereof.

### CROSS REFERENCE TO RELATED APPLICATIONS

This application is the U.S. national stage of International Application No. PCT/EP2018/050075, filed on 2018 Jan. 2. The international application claims the priority of DE 102017100034.8 filed on 2017 Jan. 2; all applications are incorporated by reference herein in their entirety.

### BACKGROUND

The present invention refers to a container for receiving, storing and dispensing liquids and/or viscous substances, in particular fuel or propellant or drinking water, a method for producing same, and use thereof.

Position control of spacecraft, such as satellites, uses (small) drives that must be supplied with fuel. The essential issue in fuel supply is in the low gravitation, in a microgravitational condition and in weightlessness that the spacecraft or satellite, respectively, is exposed to in its orbit. Due to this, the fuel will spread relatively chaotically in its container or away from the outlet opening. In order to transport the fuel from the container using the capillary effect, containers are equipped with so-called baffles. For example, EP 2 361 196 B1 describes such a container as a tank for a spacecraft. The container is intended for receiving, storing and dispensing liquids and/or viscous substances, in particular fuel or propellant. The container comprises a casing and at least one baffle for transporting the liquids and/or viscous substances. The baffle, which has a length or height, respectively, of several millimeters up to several hundred millimeters, is arranged inside the container on the inner surface of the casing and with one end facing the outlet opening of the container, protrudes completely into the inside of the container with its length or height, respectively, and extends into an area next or adjacent to the outlet opening of the container. Although this container has proven its worth immensely in practice by now due to its constructive design and has turned out to be particularly advantageous, subsequent installation of such baffles in the form of separate and individually produced parts or components at the inside of the container is relatively elaborate. Additionally, such baffles generally are only intended and suitable for transporting the liquids and/or viscous substances. Storage of the liquids and/or viscous substances, in contrast, takes place exclusively by the casing of the container or the container itself, respectively. Additionally, transport of the liquids and/or viscous substances can only take place in specific points or in a local position, respectively, i.e. only in positions where a baffle is provided additionally. The casing of the container or the container itself, respectively, and the baffle to be installed in it are not made integral with each other apart from this, let alone formed integral with each other. In order to implement a container with a baffle, various separate production steps take place in sequence instead. The baffle is only installed after production and before joining of the dome and cylinder-shaped container sections—i.e. subsequently—, which requires an elaborate effort, in the form of separate and individually produced parts or components, and attached to the casing of the container releasably by also separate attachment elements or permanently by welding or soldering. Not least due to this, there generally is a considerable additional risk from defective installation or (subsequent) damage to the baffle, which in turn may have a greatly negative effect on the directed liquid transport. The function of the baffle is limited or lost entirely. Finally, such a subsequent installation of the baffle also poses a very high risk of possible damage or even destruction of the container as a whole, which usually only has a casing thickness of a few millimeters.

### SUMMARY

The object of the present invention is therefore to provide a container for receiving, storing and dispensing liquids and/or viscous substances, in particular fuel or propellant or drinking water, by means of which the aforementioned disadvantages can be prevented, which is, therefore, formed particularly simply in terms of construction, ensures a highly reliable storage and equally continuous transport and discharge of the liquids and viscous substances held and stored in the container, in particular of fuel or propellant or drinking water, and which is extremely cost-efficient in production, a method for its production and its use.

With regard to the technical device, this object is achieved in a surprisingly simple manner by the features of claim 1.

### DETAILED DESCRIPTION

By means of the embodiment of the container according to the invention for receiving, storing and dispensing liquids and/or viscous substances, in particular fuel or propellant or drinking water, with a casing with a microscopic surface structure at least partially integrally formed on the casing, comprising at least one approximately or roughly, respectively, groove- and/or channel-shaped capillary which is arranged in an inner space of the container at the inner surface of the casing and with an end facing an outlet opening of the container, which extends towards an area adjacent to or next to the outlet opening of the container and which is formed by two side walls assigned to each other and running towards each other to convey the liquid and/or viscous substance within the capillary to the outlet opening of the container, a particularly simple construction of the container is achieved. Additionally, concurrent storage and highly reliable and equally continuous transport and discharge of the liquids and viscous substances held in the container, in particular of fuel or propellant or drinking water, is ensured by the casing of the container or the container or the container wall itself, respectively. This in particular prevents temporary or complete interruption of the fuel supply. Undersupply and lack of supply of fuel to the drives, and eventual uncontrollability of the spacecraft or satellite, respectively, are avoided. The microscopic surface structure and the casing of the container or the container or the container wall itself, respectively, are formed integral with each other. The microscopic surface structure is arranged integrally with/on the casing and/or on the inner surface of the casing—and thus as part of the casing—shaped or formed on/in the casing or integrated on and/or in it, respectively. In addition to storage of liquids and viscous substances, the casing of the container or the container or the container wall, respectively, equally inherently have the function and effect of directed transport of the liquids and viscous substances. The microscopically designed surface structure is implemented as an integral part of the manufacturing process of the casing of the container or of the container or of the container wall itself, respectively. A series and/or subsequent executions of different production steps that are entirely independent of each other—as in the state of the art for installation of the baffle—does not take place. In addition, the production of the container according to the invention is simple requiring little work and thus is particularly cost-effective. A subsequent and comparatively elaborate installation of the at least one separate and individually produced baffle by further separate and individually produced attachment elements or by welding or soldering on the inner surface of the casing of the container thus is not necessary. Damage or even destruction of the baffle and/or of the container as a whole is/are also excluded.

As a result, the container according to the invention has a multitude of benefits. Due to the design and arrangement of a microscopic surface structure on the inner surface of the casing according to the invention, it is possible to store a liquid and/or a viscous substance in a container, and to transport it from any location in a container to a reservoir at an outlet opening of the container at the same time with at least one approximately or roughly, respectively, groove- and/or channel-shaped capillary and using capillary forces—no matter the presence of gravity or other energy potentials—instead using baffles for this. This way, all difficulties coinciding with the use of baffles can be excluded extremely easily.

Advantageous structural details of the container in accordance with the invention are described in claims 2 to 15.

The features of claim 2 are of great relevance for a very simple and, therefore, cost-efficient build. Accordingly, the at least one approximately groove- and/or channel-shaped capillary is formed longitudinally or essentially longitudinally at the inner surface of the casing and arranged in a level coinciding with the length axis of the container. The at least one approximately groove- and/or channel-shaped capillary, therefore, runs at/on the inner surface of the casing similar to a meridian.

According to the measures of claim 3, the at least one approximately groove- and/or channel-shaped capillary at the inner surface of the casing extends at least partially or completely across the entire length of the container. Accordingly, it is possible to customize the length of the at least one approximately groove- and/or channel-shaped capillary to the shape and/or size or dimensions, respectively, of the container, the material properties of the container and the liquids and/or viscous substances to be received, stored in, and dispensed from, their physical characteristics, etc. Thus, it is quite possible to let the at least one approximately groove- and/or channel-shaped capillary run only across a partial length of the container, for example starting approximately from the outlet opening of the container across a lower dome section or dome to a middle container section or to approximately an upper dome section or dome of the container, or between these. In the first case, the upper dome section or dome and/or an area of the middle container section of the container adjacent to and/or following the upper dome section or dome would be designed without capillary/capillaries. In the latter case, the lower dome section, the middle container section and the upper dome section of the container, starting from the outlet opening of the container, would be completely or partially applied or provided with at least one capillary. It would also be possible to design the upper dome section entirely without any capillary/capillaries.

Moreover, it is within in the scope of the invention that the inner surface of the casing of the container according to claim 4 comprises two or more approximately groove- and/or channel-shaped capillaries.

In this connection, according to claim 5, the two or more approximately groove- and/or channel-shaped capillaries can be placed to each other at regular distances or uniformly, respectively, in particular individually and/or in groups. Particularly the two or more approximately groove- and/or channel-shaped capillaries are arranged individually and/or in groups around the circumference of the inner surface of the casing at any pitch, preferably of 180°, 120°, 90°, 60°, 30°, 15°, 10° or 5°, etc.

Further, the constructive measures of claim 6, according to which the inner surface of the casing of the container is completely or essentially completely provided with approximately groove- and/or channel-shaped capillaries, are of particular great interest in order to ensure or to at least support storage and transport of the liquid and/or viscous substance from this area towards the outlet opening of the container. In this respect, it is of particular advantage that the surface of the container is structured at the/through the container wall globally and comprehensively or at least on a large area. Transport of liquids and/or viscous substances can, therefore, not—as in the state of the art—only take place locally, but overall or in large areas of/through the surface of the container or at the inner surface of the casing of the container, respectively.

Advantageously, according to claim 7, the at least one approximately groove- and/or channel-shaped capillary has a cross-section that is wedge-shaped, semi-circular and as a pitch circle, ellipsoidal, elliptic, oval, triangular, quadrangular, square or rectangular, polygonal, trapezoidal, parallelogram-shaped or polygon-shaped and/or as a combination thereof.

According to claim 8 means for gas pressurization of the inner space or interior, respectively, of the container are assigned to the container, by which the liquid and/or viscous substance can conveyed from the container to the drive or the combustion chamber.

In this connection, in an advantageous manner, according to claim 9, the container is provided with an inlet opening, which is arranged facing away from the outlet opening of the container and which communicates with means for gas pressurization.

Moreover, it is provided by the invention that the container according to claim 10 is provided with means arranged in the area of the outlet opening and upstream of the outlet opening for collection and dosed discharge of the liquids and viscous substances, in particular the fuel or propellant or drinking water, or a similar propellant management device (PMD).

Furthermore, it is within the framework of the invention that the container is designed in a lightweight construction according to claim 11.

In advantageous manner the container, in particular the casing of the container, is made of metal, in particular of steel, stainless steel, aluminum, titanium, an alloy thereof and/or a combination thereof according to claim 12. Materials, such as preferably stainless steel, or in particular titanium or an alloy of it, on the one hand meet the demand to minimizing weight of the container and on the other hand the one to, for example, acid and corrosion resistance against fuels and propellants or suitability for drinking water.

In this connection it is of particular advantage, according to claim 13, to provide the container, in particular the casing of the container, with a coating of plastic, in particular fiber-reinforced plastic, and/or fiber composite. This increases the stiffness and strength of the container according to the invention.

Alternatively, according to the features of claim 14, the container, in particular the casing of the container, can be made of plastic, in particular of fiber-reinforced plastic, and/or fiber composite material.

Fiber composites that can be processed with any common production methods, such as manual lamination, prepreg, resin infusion, resin injection including bonded and/or bolted joints, etc., are suitable for a container according to the invention, for example for weight optimization. Accordingly the container, in particular the casing of the container, is formed of thermoplastic fiber composite material, which in particular is made of a thermoplastic matrix material of polyamide (PA), polybutylene terephthalate (PBT), polyether ketone (PEEK), polyether sulfone (PES), polypropylene (PP), polyphenylene sulphide (PPS) or polysulfone (PSU), and/or a combination thereof, without or with pre-impregnated fibers, preferably aluminum oxide, aluminum nitride, aramid, basalt, boron nitride, glass, graphite, carbon, nylon, polyethylene, polyester, silicon carbide, silicon nitride and/or ceramics fibers and/or a combination thereof.

This object is achieved, with regard to a method, in a surprisingly simple manner by the features of claims 16 and 17.

Through the embodiment of the method according to the invention, according to claim 16, for receiving, storing and dispensing liquids and/or viscous substances, in particular fuel or propellant or drinking water, with a casing and at least one approximately or roughly, respectively, groove- and/or channel-shaped capillary formed integrally with the casing, comprising the following steps:
a) providing plate-shaped semi-finished products,
b) plastic forming of the plate-shaped semi-finished products to produce individual components of the casing of the container,
c) introducing and/or applying of a microscopic surface structure (16) into/onto/to at least one of the individual components of the casing of the container with the at least one approximately groove- and/or channel-shaped capillary by using ablating or machining method, in particular by micro-milling, and/or by an embossing method and/or by an additive method, in particular by direct metal laser sintering (DMLS), selective laser melting (SLM), selective laser sintering (SLS), additive layer manufacturing (ALM), electron beam melting (EBW), and
d) joining of the individual components of the casing (12) into a container, has turned out to be particularly advantageous in practice, in addition to the many benefits already described in connection with the container according to the invention, all of which the procedure according to the invention equally has and forms, due to the extremely simple and cost-efficient production of the container according to the invention. Implementation of the microscopically designed surface structure is an integral part of the production process of the casing of the container or of the container or of the container wall as such, respectively, and is not—as in the state of the art—achieved by downstream integration of components previously produced individually. Coinciding with this, the casing of the container or the container or the container wall according to the invention, respectively, not only offers storage of the liquids and viscous substances, but also has an inherent function and effect of directed transport of the liquids and viscous substances.

The design of the method according to the invention, according to claim 17, for receiving, storing and dispensing liquids and/or viscous substances, in particular fuel or propellant or drinking water, with a casing and at least one approximately groove- and/or channel-shaped capillary formed integrally with the casing, comprising the following step:

Producing the casing of the container and introducing and/or applying of a microscopic surface structure into/onto/to the casing of the container with the at least one approximately groove- and/or channel-shaped capillary using a generative method, in particular by way of 3D-printing, direct metal laser sintering (DMLS), selective laser melting (SLM), selective laser sintering (SLS), additive layer manufacturing (ALM), electron beam melting (EBW), has the additional benefit that the casing of the container is made in a single step. In particular, however, generative production methods stand out especially for the present application, since interruptions in the microscopic surface structure, such as welding seams, which would make transport and/or conveying of the liquids and/or viscous substances and/or of the drinking water more difficult or even entirely prevent it, are avoided this way.

Finally, according to claim 18, it is within the scope of the invention to use the container according to the invention for receiving, storing and dispensing liquids and/or viscous substances, in particular fuel or propellant or drinking water, in vehicles, particularly in aerodynes or aircraft for application in aeronautics, preferably in aeroplanes and space aerodynes.

In a quite advantageous manner, according to claim 19, the container in accordance with the invention is/are suitable for receiving, storing and dispensing liquids and/or viscous substances, in particular cryogenic fluids, preferably oxygen and hydrogen, and for gaseous, liquid and solid media, preferably fuels or propellants, such as hydrazine, monomethylhydrazine (MMH), unsymmetrical dimethlyhydrazine (UDMH) or kerosine, oxidizing agents (oxidizers), such as nitrogen tetroxides or dinitrogen tetroxides (NTO), or fuel/oxidizer mixes and/or (drinking) water and waste water, for tanks and fuel tanks of rockets and/or satellites.

### BRIEF DESCRIPTION OF THE DRAWINGS

Further features, advantages and details of the invention are contained in the following description of preferred embodiments of the invention, and in connection with the drawings. The drawings are as follows:

FIG. 1 a schematic, partially cut off cross section view through an embodiment of a container designed according to the invention, with a casing with an at least partially integrally formed microscopic surface structure,

FIG. 2A a schematic, partially cut off cross section view through an embodiment of the container designed in accordance with the invention according to line II-II in FIG. 1, on an enlarged scale,

FIG. 2B a schematic, partially cut off cross section view through another embodiment of the container designed in accordance with the invention according to FIG. 2A,

FIG. 2C a schematic, partially cut off cross section view through yet another embodiment of the container designed in accordance with the invention according to FIG. 2A,

FIG. 3 a schematic cross section view through the embodiment of the container designed in accordance with the invention according to FIG. 1, on a reduced scale,

FIG. 4 a schematic cross section view through another embodiment of a container designed in accordance with the invention according to FIG. 3,

FIG. 5 a schematic lengthwise section view through an embodiment of a container designed in accordance with the invention, on a reduced scale, and

FIG. 6 bis 8 schematic lengthwise sectional views through different other embodiments of a container designed according to the invention according to FIG. 5.

### DETAILED DESCRIPTION OF THE PREFERRED EMBODIMENTS

In the following description of embodiments of the container 10 in accordance with the invention for receiving, storing and dispensing liquids and/or viscous substances, in particular fuel or propellant or drinking water, similar components that correspond to each other are each provided with identical reference numbers.

The container 10 for receiving, storing and dispensing liquids and/or viscous substances, in particular fuel or propellant or drinking water, according to the invention is used in an advantageous manner in vehicles, particularly in aerodynes or aircraft for application in aeronautics, preferably in aeroplanes and space aerodynes.

Furthermore, the container 10 according to the invention may be advantageously used for receiving, storing and dispensing liquids and/or viscous substances, in particular cryogenic fluids, preferably oxygen and hydrogen, and for gaseous, liquid and solid media, preferably fuels or propellants, such as hydrazine, monomethylhydrazine (MMH), unsymmetrical dimethlyhydrazine (UDMH) or kerosine, oxidizing agents (oxidizers), such as nitrogen tetroxides or dinitrogen tetroxides (NTO), or fuel/oxidizer mixes and/or (drinking) water and waste water, for tanks and fuel tanks of rockets and/or satellites. For example, the container 10 according to the invention is suitable for use as a rocket fuel tank or satellite tank or fuel tank, respectively, to supply (small) drives of a satellite under low gravitation, in a microgravitational condition and in weightlessness, for position control in the orbit around earth, etc.

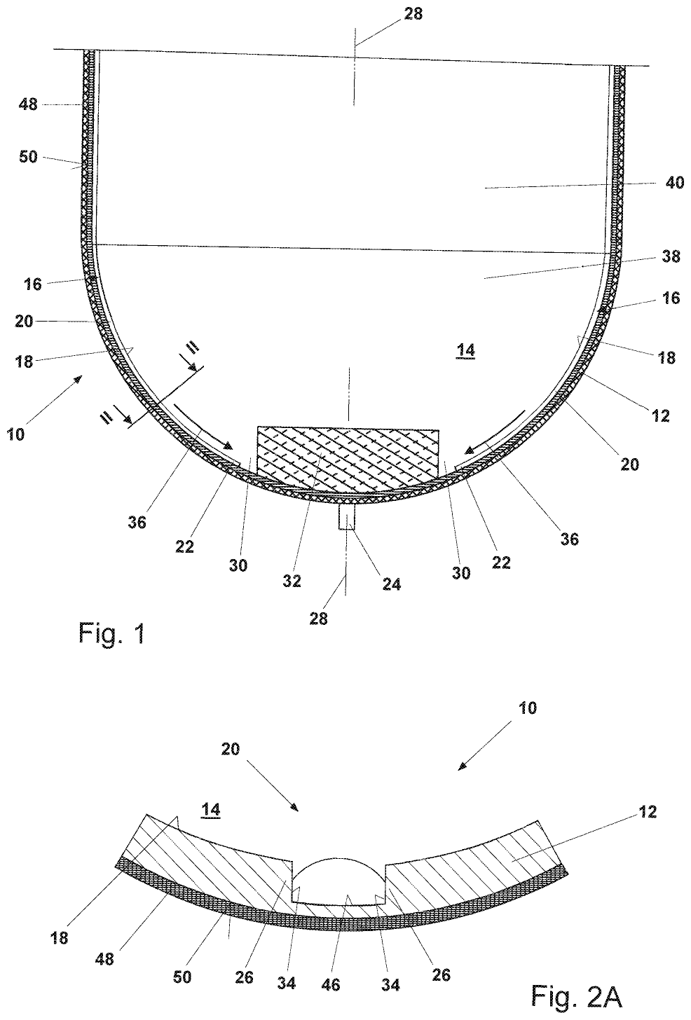

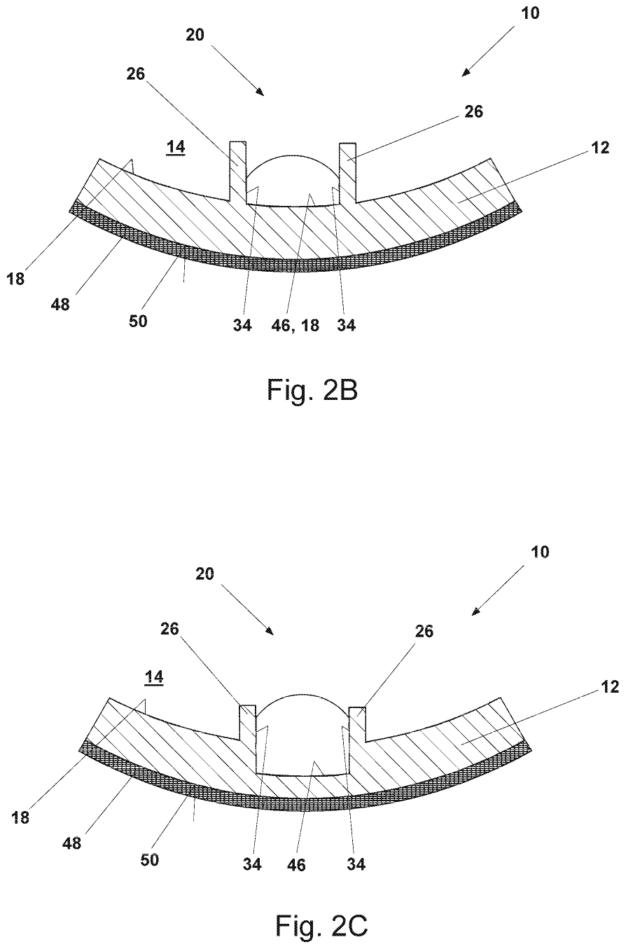

The container 10 according to the invention as schematically presented in FIGS. 1 and 2 comprises an, in particular thin-walled, casing 12, in the inner space 14 or in the interior of which, for example, cryogenic fluids such as oxygen and hydrogen, or also monomethyl hydrazine as well as various mixtures of nitrogen oxides, are received and stored, to serve, among other things, as fuels for a rocket or satellite drive and/or other drive units, for example for position control.

The casing 12 is, as only shown schematically in FIGS. 1 and 2A to 2C and, as explicitly mentioned, not to scale, at least partially provided with a microscopic surface structure 16.

The phrase “microscopic surface structure” as used above and below is to be/mean a surface structure with a length, size and/or dimension order in a range of approximately ≤(less than/equal to) 1 millimeter.

The microscopic surface structure 16 is formed and/or arranged integrally with/onto/on the casing 12. In other words, the microscopic surface structure 16 is formed in one piece with the casing 12. In yet other words, the microscopic surface

structure 16 on the inner surface 18 of the casing 12 is formed—as part of the casing 12—onto/on and/or in the casing 12 and/or formed on or integrated in it.

Beyond this, the container 10 has at least one approximately or roughly, respectively, groove- and/or channel-shaped or trough-shaped, respectively, capillary 20. The at least one groove- and/or channel-shaped capillary 20 is formed

(designed) in and/or through the microscopic surface structure 16, and therefore virtually part of the microscopic surface structure 16.

The at least one groove- and/or channel-shaped capillary 20 is arranged in the inner space 14 on the inner surface 18 of the casing 12 in the embodiment of the container 10 according to the invention shown in FIGS. 1 and 2A to 2C. Furthermore, the at least one groove- and/or channel-shaped capillary 20 is arranged with one end 22 facing an outlet opening 24 of the container 10.

In the example embodiment of FIG. 2A, the at least one groove- and/or channel-shaped capillary 20 is formed by a roughly groove-shaped cut-out or recess or indentation or groove,

respectively, in the casing 12 of the container 10. The roughly groove-shaped cut-out or recess or indentation or groove, respectively, is virtually facing the inner space 14 of the container 12 and formed by two side walls 26 and a groove base area.

In the example embodiment of FIG. 2B, the at least one groove- and/or channel-shaped capillary 20 is formed by two side walls 26 for a roughly trough- and/or groove-shaped design or a similar trough and/or groove. The two side walls 26 are assigned to each other and protrude beyond the inner surface 18 of the casing 12 as well as into the inner space 14 of the container 10.

In the example embodiment of FIG. 2C, the at least one groove- and/or channel-shaped capillary 20 is formed by a combination of the two example embodiments of FIGS. 2A and 2B. Accordingly, the at least one groove- and/or channel-shaped capillary 20 is, on the one hand, (partially) formed by a roughly groove-shaped cut-out or indentation or groove, respectively, in the casing 12 of the container 10 according to FIG. 2A and, on the other hand, (partially) formed by two side walls 26 for a roughly trough- and/or groove-shaped design or similar channel or trough or groove, respectively, according to FIG. 2B.

The embodiment of the container 10 according to the invention, which is shown in FIGS. 1 and 2A to 2C, has the at least one roughly groove- and/or channel-shaped capillary 20 formed on the inner surface 18 of the casing 12 longitudinally or essentially longitudinally, and arranged in a level that coincides with the length axis 28 of the container 10. The at least one roughly groove- and/or channel-shaped capillary 20 thus runs along the inner surface 18 of the casing 12 similar to a meridian and is thus formed straight.

As FIG. 1 shows, the at least one groove- and/or channel-shaped capillary 20 furthermore extends into an area 30 that is adjacent to the outlet opening 24 of the container 10 and/or is (preferably directly) next to it with the one end 22.

Furthermore, means or a facility, respectively, 32 and/or a refillable reservoir or similar container is arranged in accordance with FIG. 1 to collect and dispense a dosed amount of the liquids and viscous substances or of the drinking water, in particular of the fuel or propellant or drinking water, in the area 30 of the outlet opening 24. Such means 32 is also known in the relevant technical area as a so-called propellant management device (PMD).

The area 30, and as a result the means 32, are located (directly) upstream of the outlet opening 24 in this. In this way, the means 32 can collect the propellant, transport it and supply it to the outlet opening 24 in a dosed and/or controlled manner. For example, the means 32 have a storage volume of, e.g., approximately 4 liters and can be filled within approximately 1.5 hours with the design according to the invention. Further constructive measures, such as screens, sheets, etc. can additionally prevent the creation of bubbles. The propellant thus reaches the drives without bubbles from the area 30 of the outlet opening 24, via the means 32 and the outlet opening 24.

By the constructive design of the container 10 according to the invention the liquids and viscous substances distributed chaotically in the inner space 14, in particular the propellant or fuel or the drinking water, are collected via the at least one groove- and/or channel-shaped capillary 20 and/or accumulated at the capillary 20 using the capillary effect that is produced in connection with the surface tension of the liquids and viscous substances. Accumulation occurs, as shown in FIGS. 2A to 2C, on opposite side faces 34 of the two side walls 26 of the capillary 20 that face each other. The collected and/or accumulated liquids and viscous substances then flow along the side faces 34 of the capillary 20 in the direction of the arrow 36 towards its end 22 to and/or into area 30. Area 30 thus corresponds to an area where the liquids and viscous substances collect before they are transported on to the drives via the facility 32 and the outlet opening 24.

The container 10 can be equipped with any number of such capillaries 20, depending on its shape and size. The embodiment of the container 10 according to the invention of FIG. 1 only shows two such capillaries 20 as examples.

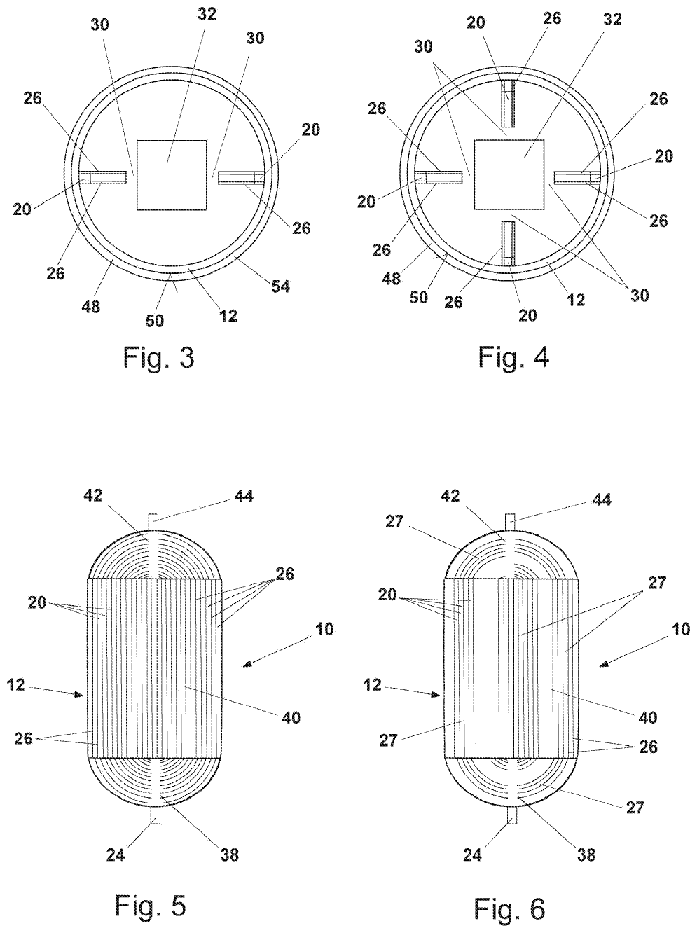

The two capillaries 20 have an even distance from each other in a preferred manner. In the embodiment of the container 10 according to the invention in accordance with FIGS. 1 and 3, therefore, the two capillaries 20 are arranged on the inner surface 18 of the casing 12 around the circumference with a pitch of roughly 180°.

As an example, in FIG. 4 an embodiment of a container 10 according to the invention is shown with four capillaries 20 that are arranged around the circumference of the inner surface 18 with a pitch of approximately 90°.

Without being presented in detail, the two or several roughly groove- and/or channel-shaped capillaries 20 at the inner surface 18 of the casing 12 of the container 10 can be placed individually and/or together, i.e. as a group, not only at regular, but also at irregular distances from each other.

It is also possible to provide more than two capillaries 20 at the inner surface 18 of the casing 12, which are then either arranged at any relation to each other and/or in regular and/or in irregular distribution around the circumference of the inner surface 18 of the casing 12. In an alternative or cumulative design, the more than two capillaries 20 at the inner surface 18 of the casing 12 can preferably also be/become arranged around the circumference with any pitch, preferably of 120°, 90°, 60°, 30°, 15°, 10° or 5°, etc., or any other pitch that may be determined based on the number of capillaries 20.

For a particularly advantageous, comprehensive and, therefore, effective conveying of liquid and/or viscous substance or drinking water, respectively, it is further within the scope of the invention to provide the inner surface 18 of the casing 12 of the container 10—around the circumference—completely or essentially completely with roughly groove- and/or channel-shaped capillaries 20.

In such an embodiment, which is shown, for example, in FIG. 5, the groove- and/or channel-shaped capillaries 20 are arranged side by side, in particular closely and/or tightly, and cover the inner surface 18 of the casing 12 on the entire surface, and in any case essentially on the entire surface, around the circumference of the inner surface 18 of the casing 12.

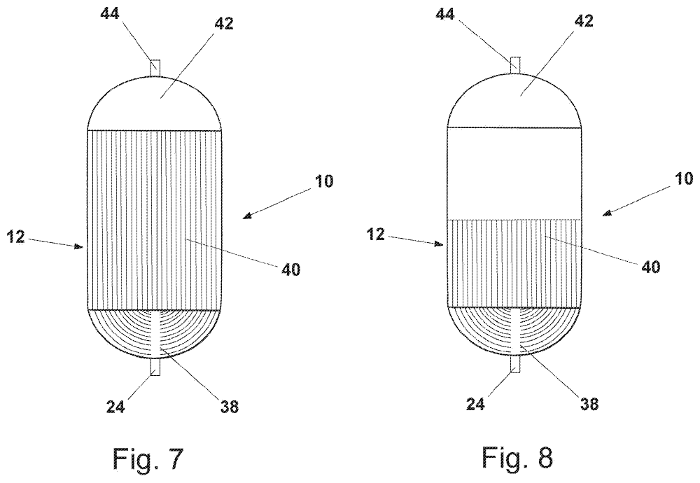

As an alternative to complete or essentially complete contouring of the inner surface 18 of the casing 12, it is also easily possible, in accordance with FIG. 6, to summarize several roughly groove- and/or channel-shaped capillaries 20—as and/or in a group—, to arrange them next to each other and to distribute them around the circumference of the inner surface 18 of the casing 12, for example in stripe segments 27.

The stripe segments 27 formed in this manner from the approximately groove- and/or channel-shaped capillaries 20 can then in turn be/become arranged regularly or irregularly towards each other and/or around the circumference of the inner surface 18 of the casing 12.

In the embodiments of FIGS. 5 and 6, i.e. when the inner surface 18 of the casing 12 is provided with the roughly groove- and/or channel-shaped capillaries 20 completely and/or essentially completely or in the form of stripe segments 27, it can be of benefit to only provide a number of n−1 side walls 26.

Alternatively or cumulatively to this, it is possible to form the at least one roughly groove- and/or channel-shaped capillary 20 at the inner surface 18 of the casing 10 at least partially or completely across the entire length of the container 10.

Further example embodiments of a container 10 designed according to the invention are schematically presented in FIGS. 7 and 8. In this respect, the length of the at least one roughly groove- and/or channel-shaped capillary 20 and/or of the plurality of roughly groove- and/or channel-shaped capillaries 20 can vary and be adjusted individually to, for example, the form and/or size or dimensions, respectively, of the container 10, its material properties and liquids and/or viscous substances to be received, stored in it, or dispensed from it, their physical characteristics or the required performance for transport and/or for conveying of a liquid and/or viscous substance and/or drinking water, etc.

For the embodiments of the container 10 of FIGS. 7 and 8, a plurality of separate, roughly groove- and/or channel-shaped capillaries 20 is suggested each, which are formed longitudinally or essentially longitudinally. The capillaries 20 are also arranged in a level coinciding with the length axis 28 of the container 10 as well as on the inner surface 18 of the casing 12 around the circumference. In both example embodiments, the capillaries 20 cover only a partial length of the container 10.

In accordance with FIG. 7, the capillaries 20 run, roughly starting at the outlet opening 24 of the container 10, across a lower dome section 38 or dome and a middle (cylinder-shaped) container section 40 towards an upper dome section 42 or dome of the container 10. The upper dome section 42, therefore, has no capillaries 20.

In accordance with FIG. 8, the capillaries 20 run, also starting roughly at the outlet opening 24 of the container 10, across the lower dome section 38 or dome and a part of the container section 40, specifically roughly across the lower half of the container section 40 of the container 10. The upper half of the container section 40 and the upper dome section 42 are, as a consequence, not equipped with capillaries 20.

Without being presented in detail, any number of other designs of the container 10 according to the invention are imaginable, as far as they can achieve a sufficient performance for transporting and/or for conveying liquid and/or a viscous substance or drinking water, respectively. For example, the capillaries 20 can be provided only in the area of the lower dome section 38 or completely across the total length of the container 10. In the latter case, the capillaries 20 run, starting roughly at the outlet opening 24 of the container 10, across the lower dome section 38, the entire container section 40 and the upper dome section 42, to an inlet opening 44 of the container 10.

The capillary/capillaries 20 also can have any cross-section that is formed wedge-shaped, semi-circular and as a pitch circle, ellipsoidal, elliptic, oval, triangular, quadrangular, square or rectangular, polygonal, trapezoidal, parallelogram-shaped or polygon-shaped and/or as a combination thereof.

In the embodiment of the container 10, as FIGS. 2A to 2C show, the two side walls 26 of the roughly groove- and/or channel-shaped capillary 20 are arranged in parallel to each other and to the length axis 28 of the container 10. The side walls 26 and their side faces 34 are planar and connected to or flow in, respectively, a pitch-circle groove base area 46 (FIGS. 2A and 2C) or a part of the inner surface 18 of the casing 12 of the container 10 (FIG. 2B), respectively.

Finally, means for gas-pressurizing the inner space 14 of the container 10 (not illustrated) are still assigned to the container 10. By the gas pressurization facility the liquid and/or the viscous substance or drinking water, respectively, may be conveyed from the container 10 to the drive and/or combustion chamber (also not illustrated), respectively.

The inlet opening 44 of the container 10 is arranged facing away from the outlet opening 24 or diametral across from it, respectively. The inlet opening 44 is usually located in the area of the pole of the upper dome section 42 and communicates with the gas pressurization facility.

The container 10 illustrated in FIGS. 1 to 8 is built in light-weight construction. The container 10, and in particular its casing 12, is formed of metal for this purpose, in particular of steel, stainless steel, aluminum, titanium, an alloy thereof and/or a combination thereof, and preferably applied with a coating 48 of plastic, in particular fiber-reinforced plastic, and/or fiber composite for pressure-reinforcing. The coating 48 is applied to the outside 50 of the casing 12 in the illustrated embodiment of the container 10 according to the invention.

Alternatively, the container 10, and in particular its casing 12, can also be formed without coating 48 or also completely of plastic, in particular fiber-reinforced plastic, and/or

fiber composite material.

The container 10, in particular the casing 12 of the container 10, is preferably be formed of thermoplastic fiber composite material. Said fiber composite material can thereby consist of polyamide (PA), polybutylene terephthalate (PBT), polyether ketone (PEEK), polyether sulfone (PES), polypropylene (PP), polyphenylene sulphide (PPS) or polysulfone (PSU), and/or a combination thereof, without or with pre-impregnated fibers, preferably aluminum oxide, aluminum nitride, aramid, basalt, boron nitride, glass, graphite, carbon, nylon, polyethylene, polyester, silicon carbide, silicon nitride and/or ceramics fibers and/or a combination thereof.

The number, the arrangement of the roughly groove- and/or channel-shaped capillary/capillaries 20 to each other and/or around the circumference of the inner surface 18 of the casing 12, the form, size and length of the roughly groove- and/or channel-shaped capillary/capillaries 20, selection of the material of the casing 12, etc. are determined by the shape and size of the container 10, the performance to be intended for transport and/or conveying of liquid and/or viscous substance or drinking water, respectively, their material properties, alone or in combination with each other, the respective different fluid-physical properties, such as surface tension, contact angle, etc., and are, as a consequence, to be individually arranged and/or adjusted to the corresponding use and the thereby specified framework conditions.

The production of the embodiments of the container 10 in accordance with the invention shown in FIGS. 1 to 8 is explained in details below:

First, plate-shaped semi-finished products are produced in accordance with step a).

Then the plate-shaped semi-finished products are formed plastically in step b) to produce individual components 38, 40, 42 and/or container sections of the casing 12 of the container 10, in particular a lower dome section 38 and an upper dome section 42 or domes as well as a middle container section 40 between the two dome sections 38, 42, for the container 10.

In step c), a microscopic surface structure 16 is introduced in and/or applied onto/to at least one of the individual components 38, 40, 42 of the casing 12 of the container 10 with the at least one roughly groove- and/or channel-shaped capillary 20 by an ablating or machining method, in particular by micro-milling, and/or by an embossing method and/or by an additive method, in particular by direct metal laser sintering (DMLS), selective laser melting (SLM), selective laser sintering (SLS), additive layer manufacturing (ALM), electron beam melting (EBW).

Finally, the respective components 38, 40 and 40, 42 and/or container sections of the casing 12 that are facing each other and adjacent to each other are joined other into a container 10 in step e).

As an alternative design, the embodiments of the container 10 according to the invention as shown in FIGS. 1 to 8 can also be manufactured solely by the step explained in more detail below:

According to this, the casing 12 of the container 10 and the microscopic surface structure 16 are formed and/or introduced and/or applied into/onto/to the casing 12 of the container 10 with the at least one roughly groove- and/or channel-shaped capillary 20 by a generative method, in particular by way of 3D-printing, direct metal laser sintering (DMLS), selective laser melting (SLM), selective laser sintering (SLS), additive layer manufacturing (ALM), electron beam melting (EBW).

The present invention is not limited to the presented embodiments of the container 10. Without being presented in detail, it is possible to combine the embodiments of the container 10 according to the invention and its individual parts among and/or with each other individually and in any manner. For example, it is easily imaginable to design the presented embodiments of the container 10 according to the invention, which are in part very different from each other, in particular the microscopic surface structure 16 at the inner surface 18 of the casing 12 and, connected to this, the at least one roughly groove- and/or channel-shaped capillary 20 as well as their design and arrangement, in any manner. Beyond this, it is possible to provide the capillary/capillaries 20 in any number, arrangement, form and dimensions, in order to achieve the most complete and therefore residue-free discharge of the liquids and/or viscous substances received, stored in, and to be dispensed from the container 10, in particular the propellant or fuel or drinking water, to the outlet opening 24 and/or the facility 32 arranged in the area 30 of the outlet opening 24 and upstream of the outlet opening 24 for collection and dosed discharge of the liquids and/or viscous substances or the like propellant management device (PMD).

1. Container for receiving, storing and dispensing liquids and/or viscous substances, in particular fuel or propellant or drinking water, with a casing (12) with a microscopic surface structure (16) at least partially integrally formed on the casing (12), comprising at least one approximately groove- and/or channel-shaped capillary (20) which is arranged in an inner space (14) of the container (10) at the inner surface (18) of the casing (12) and with an end (22) facing an outlet opening (24) of the container (10), which extends towards an area (24) adjacent to or next to the outlet opening (24) of the container (10) and which is formed by two side walls (26) assigned to each other and running towards each other to convey the liquid and/or viscous substance within the capillary (20) to the outlet opening (24) of the container (10).

2. Container according to claim 1, characterized in that the at least one approximately groove- and/or channel-shaped capillary (20) at the inner surface (18) of the casing (12) is formed longitudinally or essentially longitudinally and arranged in a level coinciding with the length axis (28) of the container (10).

3. Container according to claim 1, characterized in that the at least one approximately groove- and/or channel-shaped capillary (20) at the inner surface (18) of the casing (10) extends at least partially or completely across the entire length of the container (10).

4. Container according to claim 1, characterized in that the inner surface (18) of the casing (12) of the container (10) comprises two or more approximately groove- and/or channel-shaped capillaries (20).

5. Container according to claim 1, characterized in that the two or more approximately groove- and/or channel-shaped capillaries (20) are placed to each other at regular distances, individually and/or in groups, in particular that they are arranged individually and/or in groups around the circumference of the inner surface (18) of the casing (12) at any pitch, preferably of 180°, 120°, 90°, 60°, 30°, 15°, 10° or 5°, etc.

6. Container according to claim 1, characterized in that the inner surface (18) of the casing (12) of the container (10) is completely or essentially completely provided with approximately groove- and/or channel-shaped capillaries (20).

7. Container according to claim 1, characterized in that the at least one approximately groove- and/or channel-shaped capillary (20) has a cross-section that is wedge-shaped, semi-circular and as a pitch circle, ellipsoidal, elliptic, oval, triangular, quadrangular, square or rectangular, polygonal, trapezoidal, parallelogram-shaped or polygon-shaped and/or as a combination thereof.

8. Container according to claim 1, characterized in that means for gas pressurization of the inner space (14) of the container (10) are assigned to the container (10), by which the liquid and/or viscous substance can conveyed from the container (10) to the drive or the combustion chamber.

9. Container according to claim 8, characterized in that the container (10) is provided with an inlet opening (44) arranged facing away from the outlet opening (24) of the container (10) and communicating with the means for gas pressurization.

10. Container according to claim 1, characterized in that the container (10) is provided with means (32) arranged in the area (24) of the outlet opening (24) and upstream of the outlet opening (24) for collection and dosed discharge of the liquids and viscous substances, in particular the fuel or propellant or drinking water, or a similar propellant management device (PMD).

11. Container according to claim 1, characterized in that the container (10) is designed in a lightweight construction.

12. Container according to claim 1, characterized in that the container (10), in particular the casing (12) of the container (10), is made of metal, in particular of steel, stainless steel, aluminum, titanium, an alloy thereof and/or a combination thereof.

13. Container according to claim 1, characterized in that the container (10), in particular the casing (12) of the container (10), is provided with a coating (48) of plastic, in particular fiber-reinforced plastic, and/or fiber composite.

14. Container according to claim 1, characterized in that the container (10), in particular the casing (12) of the container (10), is made of plastic, in particular of fiber-reinforced plastic, and/or fiber composite material.

15. Container according to claim 1, characterized in that the container (10), in particular the casing (12) of the container (10), is formed of thermoplastic fiber composite material, which in particular is made of a thermoplastic matrix material of polyamide (PA), polybutylene terephthalate (PBT), polyether ketone (PEEK), polyether sulfone (PES), polypropylene (PP), polyphenylene sulphide (PPS) or polysulfone (PSU), and/or a combination thereof, without or with pre-impregnated fibers, preferably aluminum oxide, aluminum nitride, aramid, basalt, boron nitride, glass, graphite, carbon, nylon, polyethylene, polyester, silicon carbide, silicon nitride and/or ceramics fibers and/or a combination thereof.

16. Method for producing a container for receiving, storing and dispensing liquids and/or viscous substances, in particular fuel or propellant or drinking water, with a casing (12) and at least one approximately groove- and/or channel-shaped capillary (20) formed integrally with the casing (12), according to claim 1, comprising the following steps:
a) providing plate-shaped semi-finished products,
b) plastic forming of the plate-shaped semi-finished products to produce individual components (38, 40, 42) of the casing (12) of the container (10),
c) introducing and/or applying of a microscopic surface structure (16) into/onto/to at least one of the individual components (38, 40, 42) of the casing (12) of the container (10) with the at least one approximately groove- and/or channel-shaped capillary (20) by using ablating or machining method, in particular by micro-milling, and/or by an embossing method and/or by an additive method, in particular by direct metal laser sintering (DMLS), selective laser melting (SLM), selective laser sintering (SLS), additive layer manufacturing (ALM), electron beam melting (EBW), and
d) joining of the individual components (38, 40, 42) of the casing (12) into a container (10).

17. Method for producing a container for receiving, storing and dispensing liquids and/or viscous substances, in particular fuel or propellant or drinking water, with a casing (12) and at least one approximately groove- and/or channel-shaped capillary (20) formed integrally with the casing (12), according to claim 1, comprising the following step: Producing the casing (12) of the container (10) and introducing and/or applying of a microscopic surface structure (16) into/onto/to the casing (12) of the container (10) with the at least one approximately groove- and/or channel-shaped capillary (20) using a generative method, in particular by way of 3D-printing, direct metal laser sintering (DMLS), selective laser melting (SLM), selective laser sintering (SLS), additive layer manufacturing (ALM), electron beam melting (EBW).

18. Use of a container according to claim 1 for receiving, storing and dispensing liquids and/or viscous substances, in particular fuel or propellant or drinking water, in vehicles, particularly in aerodynes or aircraft for application in aeronautics, preferably in aeroplanes and space aerodynes.

19. Use of a container according to claim 1 for receiving, storing and dispensing liquids and/or viscous substances, in particular cryogenic fluids, preferably oxygen and hydrogen, and for gaseous, liquid and solid media, preferably fuels or propellants, such as hydrazine, monomethylhydrazine (MMH), unsymmetrical dimethlyhydrazine (UDMH) or kerosine, oxidizing agents (oxidizers), such as nitrogen tetroxides or dinitrogen tetroxides (NTO), or fuel/oxidizer mixes and/or (drinking) water and waste water, for tanks and fuel tanks of rockets and/or satellites.
